(19) United States
(12) Patent Application Publication
(10) Pub. No.: US 2024/0354236 A1
(43) Pub. Date: Oct. 24, 2024

(54) METHOD FOR GENERATING AT LEAST ONE NEW TEST CASE FOR A FUZZING SOFTWARE TEST

(71) Applicant: Robert Bosch GmbH, Stuttgart (DE)

(72) Inventors: Maria Irina Nicolae, Stuttgart (DE); Martin Ring, Lossburg (DE)

(21) Appl. No.: 18/625,279

(22) Filed: Apr. 3, 2024

(30) Foreign Application Priority Data
Apr. 20, 2023 (DE) 10 2023 203 627.4

(51) Int. Cl. G06F 11/36

(52) U.S. Cl. CPC G06F 11/3684; G06F 11/368

(57) ABSTRACT

A method for generating at least one new test case for a fuzzing software test. The method includes: providing at least one existing test case for the fuzzing software test, wherein the fuzzing software test is provided for testing at least one of a plurality of different forms of a test target; generating representation information on the basis of the at least one existing test case and on the basis of an effect of training test cases on a plurality of the different forms of the test target; generating the at least one new test case for the fuzzing software test on the basis of the representation information.

### CROSS REFERENCE

The present application claims the benefit under 35 U.S.C. § 119 of German Patent Application No. DE 10 2023 203 627.4 filed on Apr. 20, 2023, which is expressly incorporated herein by reference in its entirety.

### FIELD

The present invention relates to a method for generating at least one new test case for a fuzzing software test. In addition, the present invention relates to a training method, a machine-learning model, a computer program, a device, and also a storage medium for this purpose.

### BACKGROUND INFORMATION

It is common for software to be changed several times over the course of time, in particular in the application of agile development methods, in the elimination of errors or in the adaptation of functions. Current software development practice promotes the use of continuous integration and development pipelines (CI/CD) that make it possible to test each version of the software over time.

It is also usual for multiple software programs to support the same message or protocol format as input (for example, JPEG, XML, PDF, CAN). When fuzzing such target programs, it is possible to use a formal grammar specification (cf. [1], [4], the references being listed at the end of the description) in order to generate valid test cases for the particular format.

However, the implementation can deviate from the specification, or the grammar describes the interface only inadequately. In practice, the most interesting test cases are those that show the discrepancies between the grammar and the software since these could represent errors. In addition, it is possible for the interface to be too complex for a simple definition of the grammar. For many input formats, definition of the grammar is the most difficult aspect.

### SUMMARY

The present invention relates to a method, a training method, a machine-learning model, a computer program, a device, as well as a computer-readable storage medium. Features of and details relating to the present invention can be found in the disclosure herein. Here, features and details which are described in connection with the method according to the present invention naturally also apply in connection with the training method according to the present invention, the machine-learning model according to the present invention, the computer program according to the present invention, the device according to the present invention, as well as the computer-readable storage medium according to the present invention, and vice versa in each case, so that, with regard to the disclosure of individual aspects of the present invention, reference is or can always be made reciprocally.

The present invention relates in particular to a method for generating at least one new test case for a fuzzing software test. According to an example embodiment of the present invention, the method includes the following steps, which are preferably executed successively and/or repeatedly:
providing at least one existing test case for the fuzzing software test, wherein the fuzzing software test can be provided for testing at least one form of a plurality of different forms of a test target,
generating representation information on the basis of the at least one existing test case and on the basis of an effect of training test cases on a plurality of the different forms of the test target,
generating the at least one new test case for the fuzzing software test on the basis of the generated representation information.

It can thus be an advantage of the present invention that new test cases can be generated automatically which extend over the different forms of the test target, for example, different target programs and/or a plurality of versions of a target program, preferably including larger releases and also with possible changes to the interfaces that need to be fuzzed. Here, the representation information can be an embedding, i.e., in particular, can form a representation of the mapping between the test cases, in particular of target program inputs, and effects, in particular in the form of coverage information. The coverage information can be information about a code coverage in the target programs or the different versions. The method according to the present invention thus makes it possible, in particular, to use the findings from a version of a code base also for testing future versions of the same software.

Fuzzing, also referred to as fuzz testing, is a dynamic software test method, which is for example described in more detail in [6]. In fuzzing, invalid, unexpected or random data can be input as inputs into software for the automated execution of software tests. The software to be tested is also referred to below as the target program, fuzz target or the program to be tested.

By means of fuzzing, the target program can be monitored for exceptions such as crashes, failed integrated code assertions or potential memory leaks. Fuzzers that process structured inputs can be used here for testing target programs. This structure is specified, for example in a determined format or protocol, and distinguishes valid from invalid inputs. An effective fuzzer can therefore generate semi-valid inputs that are “valid enough” to not be rejected immediately by the target program but cause unexpected behaviors in the deeper areas of the target program and are “invalid enough” to reveal corner cases that have not been handled properly. Fuzz testing or fuzzing can thus comprise an automated process in which randomly generated inputs are sent to a target program and the reaction thereof is observed. A fuzzer, also referred to as a fuzzing engine, is therefore software which automatically generates inputs. A fuzzer can be capable of instrumenting code, generating test cases, and executing target programs that are to be tested. Well-known examples of fuzzers are AFL und libFuzzer.

The software to be tested can also be referred to as the target program or fuzz target. The target program is understood to be a software program having a plurality of functions, or even to be just one function that is to be tested by fuzzing. A main feature of a fuzz target can be that it processes potentially untrustworthy inputs that are generated by the fuzzer during the fuzzing process. In addition, a fuzz test can be provided which represents the combined version of a fuzzer and a fuzz target. A fuzz target can be an instrumented code, the inputs of which are provided with a fuzzer. A fuzz test can be executable. The fuzzer can also start, observe and stop a plurality of running fuzz tests (for example, hundreds or thousands per second), each having a somewhat different input generated by the fuzzer.

A test case can be a specific input and/or a test run of a fuzz test. In order to ensure reproducibility, relevant test runs (which reveal new code paths or crashes) can be saved. In this way, a specific test case having the corresponding input can also be executed on a fuzz target which is not connected to a fuzzer, for example in its release version.

In addition, it is still possible for a coverage-guided fuzzing to be provided. This uses code coverage information as feedback during fuzzing in order to detect whether an input has caused the execution of new code paths or blocks. Furthermore, a generation-based fuzzing can also be provided which uses prior knowledge about the target program to be tested in order to create test inputs. An example is grammars that match the input specification.

According to an example embodiment of the present invention, the fuzzing can also be implemented as a mutation-based fuzzing. In this case, new program inputs are generated by making small changes to existing inputs (also called seeds) which continue to keep the input valid but trigger a new behavior. A seed is an initial program input that can be used as a starting point for mutation-based fuzzing. Seeds can generally be provided by the user. The energy of a seed is the number of test cases which can be generated from a seed by mutations. The performance plan is the importance that a mutation-based fuzzer assigns to the seeds, which directly affects the order in which the seeds are queued for the mutation.

A static instrumentation is understood in particular to mean the insertion of instructions into a target program in order to obtain feedback about its execution. It is usually realized by the compiler and can, for example, describe the code blocks reached during execution. Dynamic instrumentation is the monitoring of the execution of a target program during the runtime in order to obtain feedback about the execution. It is realized, for example, by operating system functionalities or by the use of emulators.

According to an example embodiment of the present invention, in order to carry out the software tests, a debugger can also be provided in order to control a target program and provide functions, for example for retrieving register or memory values and for pausing and interrupting the execution in single steps. A breakpoint can be set via a debugger on an instruction of the target program in order to pause execution when it is reached and to inform the controlling process about this. A data watchpoint can be set via a debugger on a memory address of the target program in order to stop execution when said memory address is accessed, and to inform the controlling process about this.

Within the scope of the present invention, an in particular conventional fuzzing can be expanded by machine learning methods. According to an example embodiment of the present invention, for this purpose, a machine-learning model can be trained to generate test cases for a software test, in particular to generate relevant test cases for testable interfaces across target program versions and/or to generate relevant test cases for the test of a plurality of target programs. For example, a machine-learning model can be trained in order to learn to generate relevant test cases for testable interfaces across target program versions, in particular without a grammar being required. The trained model, which learns from a plurality of versions of the same target program, can thus be a generalization of the interfaces, which makes regression tests possible on the basis of the generated input. In addition, the changes in the input of the target program to be tested can represent targets of interest for the fuzzer, since corner cases of interest are embedded in these changes, which corner cases are rarely tested during normal system or integration tests. Furthermore, a machine-learning model can be trained to learn to generate relevant test cases for the test of a plurality of target programs, in particular without a grammar being required. The proposed approach, which learns from a plurality of target programs, can aim at generalizing between these and other target programs that accept the same input format. The trained machine-learning model can generate the representation information as output and in particular on the basis of this generalization.

According to an example embodiment of the present invention, it may also be possible for the at least one new test case to be generated on the basis of the at least one existing test case and of the representation information in that a model, preferably a or the machine-learning model, preferably a trained neural network and/or an encoder, is applied in order to generate the representation information. The model can have been trained on the basis of a prediction of the effect. In other words, a model can have been trained to generate new, relevant test cases on the basis of existing test cases. The representation information can be calculated, for example, as the output of an encoder of the model for the at least one specified test case, preferably for a given target program input.

According to an example embodiment of the present invention, it is also advantageous if the effect results from a fitness function and/or of a performance metric which quantifies a success of the training test cases. The effect is preferably a code coverage in the test target. The effect can be ascertained, for example, in the training during the execution of the training test cases in the forms of the test target, in particular target programs and/or the different versions of the target program. The fitness function can, for example, evaluate the number of successful test cases for a determined function and/or output a value that is specific to a success of the test. A performance metric can also be used which is specific to an effect of the test case in the test target, such as a code coverage and/or a memory utilization and/or an execution time of the test target.

According to a further advantage, the existing test case can be implemented as a seed, and the at least one new test case is generated on the basis of the representation information in that mutations of the seed are ascertained with the aid of the representation information. Mutations of a seed are changes in the specified test case in order to generate different variations and thus to achieve better results in the software test. The mutations are generated, for example, by a mutations generator which, for this purpose, evaluates the output of the model. The output is, for example, an array of data that are specific to a new test case.

According to an advantageous development of the present invention, the different embodiments of the test target can comprise different target programs and/or different versions of a target program, which preferably have an identical input format for an input (target program input) resulting from the test cases. The input format can be, for example, a message format and/or protocol format (for example, JPEG, XML, PDF, CAN) and/or a format for a file and/or a command line argument and/or a network request.

According to an example embodiment of the present invention, it is also advantageous if the new test case generated is executed by the fuzzing software test for testing the at least one form of the test target, wherein the at least one form of the test target can comprise a (target) program and/or an embedded system, optionally for controlling an at least partially autonomous robot, preferably a vehicle. The vehicle is, for example, a motor vehicle and/or an autonomous vehicle.

The present invention also relates to a training method for training a machine-learning model, preferably according to the present invention, for generating at least one new test case for a fuzzing software test, preferably for use in a method according to the present invention. According to an example embodiment of the present invention, the training method includes the following steps:
providing training test cases, preferably by means of an at least partially manual and/or automated random definition of the training test cases,
providing different forms of a test target, preferably different versions of a target program and/or different target programs,
training the machine-learning model for outputting representation information and/or for predicting an effect of the training test cases on the different forms of the test target, wherein the prediction can be made on the basis of the output representation information,
providing the trained machine-learning model for use in the generation of the at least one new test case, preferably in a method according to the present invention.

The training method according to the present invention thus delivers the same advantages as have been described in detail with reference to a method according to the present invention.

The present invention also relates to a machine-learning model which results from a training method according to the present invention. The machine-learning model according to the present invention thus delivers the same advantages as have been described in detail with reference to a method according to the present invention.

According to an example embodiment of the present invention, the (machine-learning) model can comprise an encoder which is or has been trained for outputting the representation information such as an embedding. For this purpose, further layers can be provided in the training, in particular decoders which are assigned to the different forms of the test target. The training can be carried out, for example, by means of training data and/or training methods such as backpropagation in order to optimize the model to predict an effect of the training test cases on the test target. This can mean that the effect, such as a code coverage in the different forms of the test target, is predicted, preferably by the relevant decoders. In this case, it may be possible for the predictions for the different forms of the test target, such as the different target programs and/or versions, to be taken into account jointly for the training of the model. In other words, the model having the (in particular single) encoder and the decoders can be adapted or trained together in the training to predict the effect of the training test cases for a plurality of forms of the test target. For this purpose, the annotation data required for this can be ascertained, for example, in that the effect, such as the code coverage, has previously been ascertained for the training test cases. As a result of the training, for example, only the encoder can be provided as a trained model in order to generate further test cases by mutation on the basis of the representation information that can be generated by this.

The present invention also relates to a computer program, in particular a computer program product, comprising commands which, when the computer program is executed by a computer, cause the computer to carry out the method according to the present invention. The computer program according to the present invention thus delivers the same advantages as have been described in detail with reference to a method according to the present invention.

The present invention also relates to a device for data processing that is configured to carry out the method according to the present invention. For example, a computer which executes the computer program according to the present invention can be provided as the device. The computer can have at least one processor for executing the computer program. A non-volatile data memory can also be provided, in which the computer program is stored and from which the computer program can be read by the processor for execution.

The present invention can also relate to a computer-readable storage medium which comprises the computer program according to the present invention and/or commands which, when executed by a computer, cause the computer to carry out the method according to the present invention. The storage medium is formed, for example, as a data memory such as a hard drive and/or a non-volatile memory and/or a memory card. The storage medium can be integrated into the computer, for example.

Furthermore, the method according to the present invention can also be carried out as a computer-implemented method.

Further advantages, features and details of the present invention can be found in the following description, in which exemplary embodiments of the present invention are described in detail with reference to the figures. The features disclosed herein can be essential to the present invention, individually or in any combination.

### BRIEF DESCRIPTION OF THE DRAWINGS

FIG. 1 is a schematic visualization of the method, a machine-learning model, a device, a storage medium and also a computer program according to exemplary embodiments of the present invention.

FIG. 2 shows exemplary embodiments of the present invention, in which training is performed for generating test cases having a plurality of versions of a target program.

FIG. 3 shows an application of a trained machine-learning model.

FIG. 4 shows exemplary embodiments of the present invention, in which a plurality of different target programs are taken into account in the training.

### DETAILED DESCRIPTION OF EXAMPLE EMBODIMENTS

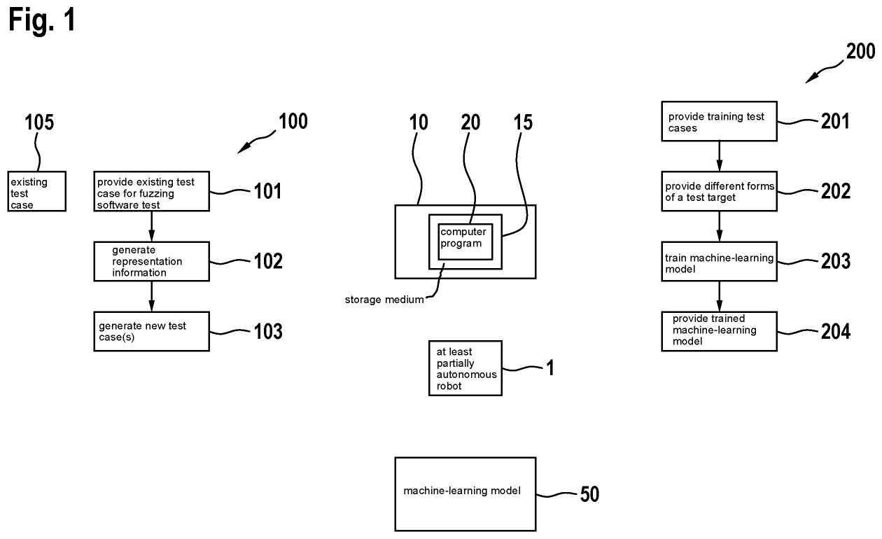

FIG. 1 schematically shows a method 100, a training method 200, a machine-learning model 50, a device 10, a storage medium 15, and also a computer program 20 according to exemplary embodiments of the present invention. The method 100 is intended to generate at least one new test case 110 for a fuzzing software test. According to a first method step 101, at least one existing test case 105 can firstly be provided for the fuzzing software test. The fuzzing software test can be provided for testing at least one of a plurality of different forms of a test target 170, 180. Subsequently, according to a second method step 102, representation information 152 can be generated on the basis of the at least one existing test case 105 and on the basis of an effect of training test cases on a plurality of the different forms of the test target 170, 180. For this purpose, the effect, for example within the scope of a machine learning method, can be determined beforehand with the aid of the training test cases. According to a third method step 103, at least one new test case 110 for the fuzzing software test can then be generated on the basis of the representation information 152. The at least one new test case 110 can preferably be generated on the basis of the at least one existing test case 105 and on the basis of the representation information 152 in that a trained model 50, preferably a machine-learning model 50, preferably a trained neural network 50 and/or an encoder 151, is applied in order to generate the representation information 152. The model 50 can have been trained by the machine learning method on the basis of a prediction of the effect. The new test case 110 generated by the fuzzing software test can be executed for testing the at least one form of the test target 170, 180, wherein the at least one form of the test target 170, 180 can comprise a program 170 and/or an embedded system 170, preferably for controlling an at least partially autonomous robot 1, preferably a vehicle 1.

For the training, a training method 200 can be used in which, according to a first training step 201, training test cases are provided and, according to a second training step 202, different forms of a test target 170, 180 are provided. Next, according to a third training step 203, the training of the machine-learning model 50 can be carried out for outputting representation information 152 and for predicting an effect of the training test cases on the different forms of the test target 170, 180. The prediction can be made on the basis of the output representation information 152. According to a fourth training step 204, the trained machine-learning model 50 can then be provided for use in the generation of the at least one new test case 110.

An advantage of embodiment variants of the present invention results in particular in that new test cases 110 can be generated for target programs 170 that accept the same input format. The test cases 110 can be used, for example, in what is known as greybox fuzzing. Greybox fuzzing is supported by multiple modern open-source tools such as AFL [9], AFL++ [3] and libFuzzer [5]. Greybox fuzzing is a technique for automatically generating test inputs, in which a part of the program code is known, in order to identify points of attack in a targeted manner. The formal grammar specification [1], [4] can be used for generating test cases and can be capable of functioning across software versions which in principle accept the same grammar. However, the implementation may deviate from the specification, or the grammar may inadequately describe the interface. It is also possible for the interface to be too complex for a simple definition of a grammar. Exemplary embodiments of the present invention can therefore have the advantage that the derivation or learning of a grammar is not required. To make this possible, machine learning can be used for generating test cases for a plurality of target programs and/or target program versions. The approach based on machine learning can in principle have two main steps: training a machine-learning model on the basis of a training set of a number of existing test cases, and fuzzing using the trained machine-learning model.

Training of a machine-learning model on the basis of target program inputs for predicting the code coverage has, for example, already been presented by Neuzz [8]. The trained neural network can be used here to generate test cases in a standard greybox fuzzing loop. MTFuzz [7] expanded the earlier approach to multi-task learning by using multiple types of code coverage for the same target program when training the model. However, in these approaches, it can be problematic to handle a plurality of versions of the target program to be tested or a plurality of target programs to be tested.

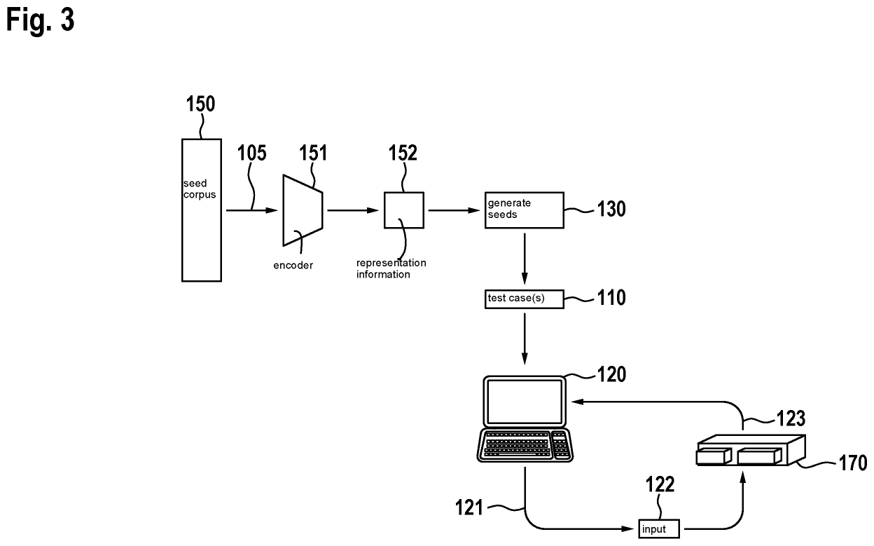

Proceeding from a typical greybox fuzzing setup shown in FIG. 3, which comprises a seed corpus 150, a fuzzer 120, and a target program 170, a greybox fuzzer can feed test cases 110 into the target program 170 and observe its behavior and code coverage for each input 122 (feedback loop 123). Here the code coverage shows in particular which parts of the source code of the target program 170 were executed during the test and which were not. Greybox fuzzing is in particular a technique combining elements of whitebox and blackbox fuzzing. The fuzzer 120 is given a certain amount of knowledge about the target program 170 to be tested in order to perform more-targeted and more-effective tests. In addition to the fuzzer 120 for automatic generation 121 of test inputs and the seed corpus 150 for the generation 130 of seeds, a code analysis for analyzing the source code of the target program 170 and an instrumentation for injecting code into the target program 170 can also be provided here.

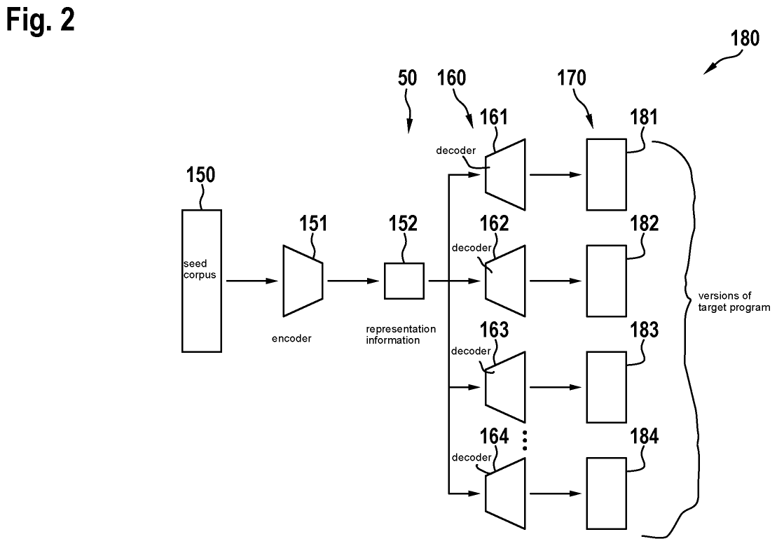

FIG. 2 shows training of exemplary embodiments of the present invention in which a plurality of versions 180 of a target program 170 are taken into account. By way of example, it is assumed that a plurality of versions 181, 182, 183, 184 of the target program 170 are available which correspond to the development of the code over time. According to FIG. 3, exemplary embodiments of the present invention can contribute to the generation 130 of new test cases 110 and for this purpose use the information from the historical code base. This function can be obtained by machine learning. For this purpose, the same test cases 105 can run on the available versions 180 of the target software and the code coverage observed, which they bring about in each version 180. A machine-learning model 50, which can be used for supervised learning, for example a neural network, can be trained here in a multi-tasking setup [2]. The test cases 105 can be used as input and the corresponding code coverage as output. In this case, in particular on the basis of the multi-tasking aspect, the neural network has a plurality of outputs, preferably one for each available software version.

The layers of the neural network up to the division amongst the software versions are referred to as encoders 151, whereas the subsequent layers, which are each assigned to a determined version 180, represent a decoder 160. In FIG. 2, by way of example, a first decoder 161 is assigned to a first target program version 181, a second decoder 162 is assigned to a second target program version 182, a third decoder 163 is assigned to a third target program version 183 and a fourth decoder 164 is assigned to a fourth target program version 184. The aim of the machine-learning model 50 is in particular to learn a hidden, potentially compressed representation of the mapping between target program inputs and coverage information, which is referred to as embedding 152. This embedding 152 can be calculated as an output of the encoder 151 for a given target program input 122. With this approach, a unique embedding 152 can be obtained for each input 122, preferably independently of the number of available software versions.

Once the model 50 has been trained with existing test cases 105 and coverage information, it can be integrated into a fuzzing feedback loop, with the aim of generating new test cases 110. In particular, only the encoder 151 is used for the test case generation up to the hidden representation. FIG. 3 shows the fuzzing loop having the trained encoder 151. Proceeding from an existing test case 105 as seed, the encoder 151 can generate its hidden representation 152, which can be used at 130 to calculate mutations of the seed which lead to new, relevant test cases 110 for any version 180 of the software, preferably including a new version 180 which has not been used for training. The strategy of using this method can be observed and the results are visible.

In particular in the context of fuzzing software tests, seed is understood to be a starting position or an initial value from which the test cases 110 are generated. Since random or semi-random data can be fed as input 122 into the target program 170 during fuzzing in order to identify unexpected behavior or vulnerabilities, it can happen that fuzzing tests generate non-productive inputs 122. A seed input 122 can therefore be used, which is used as a starting point for generating input data. This starting position can be selected such that it steers the test sequence in a determined direction and has a greater chance of discovering relevant, i.e., interesting or critical, vulnerabilities. The seed input 122 can in particular be generated by the seed corpus 150.

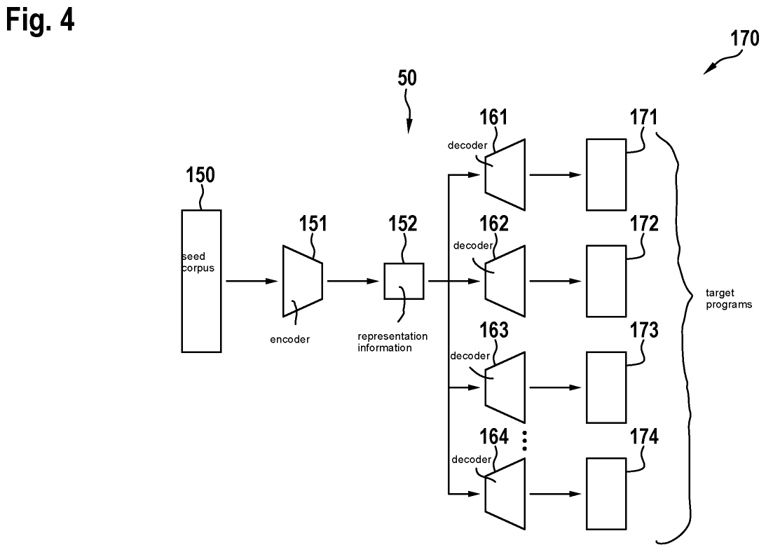

FIG. 4 shows exemplary embodiments of the present invention in which a plurality of different target programs 170 are taken into account in the training. In the following, it is assumed by way of example that a plurality of target programs 171, 172, 173, 174 are available which accept the same input format. It may be an aim here to solve the problem of generating new test cases 110, which are based on all available target programs 170, by machine learning. In this case, the same test cases 110 can be run on the available target programs 170 and the code coverage can be observed, which they bring about in each target program 170. Here, too, a machine-learning model 50, which can be used for supervised learning, for example a neural network, can be trained in a multi-tasking setup [2]. The test cases 105 can here be used as input and the corresponding code coverage as output. Here too, the multi-tasking aspect also implies that the neural network has a plurality of outputs, one per target program 170.

In FIG. 4, by way of example, a first decoder 161 is assigned to a first target program 171, a second decoder 162 is assigned to a second target program 172, a third decoder 163 is assigned to a third target program 173, and a fourth decoder 164 is assigned to a fourth target program 174. The aim of the machine-learning model 50 is to learn a hidden, potentially compressed representation of the assignment between target program inputs and acquisition information, i.e., the embedding 152. This embedding 152 can be calculated as an output of the encoder 151 for a given target program input. A unique embedding 152 can be obtained for each input 122, in particular independently of the number of available target programs 170. As soon as the model has been trained with existing test cases 105 and coverage information, it can be integrated into a fuzzing feedback loop, with the aim of generating new test cases 110. Only the encoder 151 can be used for the test case generation up to the hidden representation. FIG. 3 shows the fuzzing loop having the trained encoder. Starting from an existing test case 105 as seed, the encoder 151 can generate its hidden representation 152, which can be used to calculate mutations of the seed, which leads to new, relevant test cases 110 for each target program 170, even for a new target program 170 which has not been used for the training.

The above description of the embodiments describes the present invention exclusively in the context of examples. Of course, individual features of the embodiments, provided they are technically meaningful, can be freely combined with one another without departing from the scope of the present invention.

### REFERENCES

[1] Hamad Al Salem and Jia Song. A review on grammar-based fuzzing techniques. volume 13, 2019.
[2] Rich Caruana. Multitask learning. Machine Learning, 28:41-75, 1997.
[3] Andrea Fioraldi, Dominik Maier, Heiko Eißfeldt, and Marc Heuse. AFL++: Combining incremental steps of fuzzing research. In USENIX Workshop on Offensive Technologies (WOOT). USENIX Association, 2020.
[4] Rahul Gopinath, Björn Mathis, and Andreas Zeller. Mining input grammars from dynamic control flow. In ACM Joint Meeting on European Software Engineering Conference and Symposium on the Foundations of Software Engineering, pages 172-183, 2020.
[5] libFuzzer authors. libFuzzer—a library for coverage-guided fuzz testing. https://llvm.org/docs/LibFuzzer. html, 2017.
[6] Valentin Jean-Marie Man'es, HyungSeok Han, Choongwoo Han, Sang Kil Cha, Manuel Egele, Edward J Schwartz, and Maverick Woo. The art, science, and engineering of fuzzing: A survey. IEEE Transactions on Software Engineering, 2019.
[7] Dongdong She, Rahul Krishna, Lu Yan, Suman Jana, and Baishakhi Ray. Mtfuzz: fuzzing with a multi-task neural network. In ACM Joint European Software Engineering Conference and Symposium on the Foundations of Software Engineering (ESEC/FSE), 2020.
[8] Dongdong She, Kexin Pei, Dave Epstein, Junfeng Yang, Baishakhi Ray, and Suman Jana. Neuzz: efficient fuzzing with neural program smoothing. In IEEE Symposium on Security and Privacy (S&P), 2019.
[9] Michal Zalewski. American fuzz lop. https://github.com/google/AFL, 2020.

What is claimed is:

1. A method for generating at least one new test case for a fuzzing software test, the method comprising the following steps:
providing at least one existing test case for the fuzzing software test, wherein the fuzzing software test is provided for testing at least one of a plurality of different forms of a test target;
generating representation information based on the at least one existing test case and based on an effect of training test cases on a plurality of the different forms of the test target; and
generating the at least one new test case for the fuzzing software test based on the representation information.

2. The method according to claim 1, wherein the at least one new test case is generated based on the at least one existing test case and of the representation information, by a model being applied to generate the representation information, wherein the model is trained based on a prediction of the effect.

3. The method according to claim 1, wherein the effect results from a fitness function and/or a performance metric, which quantifies a success of the training test cases, wherein the effect is a code coverage at the test target.

4. The method according to claim 1, wherein the existing test case is implemented as a seed, and the at least one new test case is generated based on the representation information by mutations of the seed being ascertained using the representation information.

5. The method according to claim 1, wherein the different forms of the test target include different target programs and/or different versions of a target program, which have an identical input format for an input resulting from the test cases.

6. The method according to claim 1, wherein the new test case generated is executed by the fuzzing software test for testing the at least one form of the test target, wherein the at least one form of the test target includes a program and/or an embedded system for controlling an at least partially autonomous robot.

7. A training method for training a machine-learning model for generating at least one new test case for a fuzzing software test, comprising the following steps:
providing training test cases;
providing different forms of a test target;
training the machine-learning model for outputting representation information and for predicting an effect of the training test cases on the different forms of the test target, wherein the prediction is performed on the basis of the output representation information; and
providing the trained machine-learning model for use in generating the at least one new test case.

8. A machine-learning model configured to generate at least one new test case of a fuzzing software test, the machine-learning model being trained by:
providing training test cases;
providing different forms of a test target;
training the machine-learning model for outputting representation information and for predicting an effect of the training test cases on the different forms of the test target, wherein the prediction is performed on the basis of the output representation information; and
providing the trained machine-learning model for use in generating the at least one new test case.

9. A device for data processing, the device for generating at least one new test case for a fuzzing software test, the method comprising the following steps:
providing at least one existing test case for the fuzzing software test, wherein the fuzzing software test is provided for testing at least one of a plurality of different forms of a test target;
generating representation information based on the at least one existing test case and based on an effect of training test cases on a plurality of the different forms of the test target; and
generating the at least one new test case for the fuzzing software test based on the representation information.

10. A non-transitory machine-readable storage medium on which are stored commands for generating at least one new test case for a fuzzing software test, the commands, when executed by a computer, causing the computer to perform the following steps:
providing at least one existing test case for the fuzzing software test, wherein the fuzzing software test is provided for testing at least one of a plurality of different forms of a test target;
generating representation information based on the at least one existing test case and based on an effect of training test cases on a plurality of the different forms of the test target; and
generating the at least one new test case for the fuzzing software test based on the representation information.
